(19) United States
(12) Patent Application Publication
(10) Pub. No.: US 2018/0324075 A1
(43) Pub. Date: Nov. 8, 2018

(54) COMMUNICATION APPARATUS AND CONTROL METHOD THEREOF AND COMMUNICATION SYSTEM

(71) Applicant: CANON KABUSHIKI KAISHA, Tokyo (JP)

(72) Inventor: Yuji Kawai, Yokohama-shi (JP)

(21) Appl. No.: 15/966,050

(22) Filed: Apr. 30, 2018

(30) Foreign Application Priority Data
May 2, 2017 (JP) 2017-091944

(51) Int. Cl. H04L 12/26; H04L 29/08

(52) U.S. Cl. CPC H04L 43/103; H04W 4/80; H04L 67/025; H04L 67/10

(57) ABSTRACT

According to the present invention, response processing to a predetermined polling request is accepted from a client, and, even when a response to the request has not been sent, the client can shift to another processing by accepting a new request. Accordingly, a communication apparatus includes a communication unit that performs communication by using a request/response communication protocol; a processing unit that performs processing corresponding to a request received from a client, and sends a response to the client; and a control unit that, when receiving a predetermined polling request, and the processing unit receives another request from the client before sending a response to the predetermined polling request to the client, sends a cancellation response to the predetermined polling request, and causes the processing unit to execute processing corresponding to the other request.

### BACKGROUND OF THE INVENTION

### Field of the Invention

The present invention relates to a communication apparatus and a control method thereof, and a communication system.

### Description of the Related Art

With the recent increase in the degree of integration of wireless communication devices, not only a portable personal computer (so-called a notebook PC), but also a printer, a mobile information terminal, a digital camera, a smart device, a smartphone, and the like are increasingly equipped with a wireless LAN function. Consequently, those devices that have conventionally had only communication means via wired connection such as USB connection with a specific device are now capable of performing data communication with various devices as the result of having wireless communication means. For example, it is possible to connect a smart device and a digital camera, and save an image captured with the digital camera in the smart device. At present, it is also possible for the digital camera to function as a server to implement remote shooting by using a server/client system such as HTTP.

In a system such as a server/client system, there is often a certain limitation in voluntarily providing some notification from the server to the client. In this respect, it is possible that the server voluntarily notifies the client at the necessary timing (long polling) by the client sending a request first, and the server maintaining a holding state of that response. As such a method, there is a method in which a state notification request is sent in advance, and a response is returned at the timing at which the server state has changed (e.g., Japanese Patent Laid-Open No 2013-021526).

However, in a period during which a response is returned after the client has sent a long polling request to the server, the user may wish to execute another function by operating the smart device. In this case, it is wasteful to maintain communication for long polling when executing the other function.

### SUMMARY OF THE INVENTION

According to an aspect of the present invention, there is provided a communication apparatus comprising: a communication unit that communicates with a client by using a request/response communication protocol; a processing unit that performs processing corresponding to a request received by the communication unit from the client, and enables the communication unit to send a response to the received request to the client; and a control unit that, when the communication unit receives a predetermined polling request, and the processing unit receives another request from the client before sending a response to the predetermined polling request to the client, sends a cancellation response to the predetermined polling request from the communication unit, and causes the processing unit to execute processing corresponding to the other request.

According to the present invention, it is possible to prevent a situation where communication for long polling is wastefully maintained.

Further features of the present invention will become apparent from the following description of exemplary embodiments (with reference to the attached drawings).

### BRIEF DESCRIPTION OF THE DRAWINGS

FIGS. 1A to 1C are a block diagram showing a configuration of a digital camera according to a first embodiment, and external views thereof.

FIG. 2 is a block diagram showing a configuration of a smart device according to the first embodiment.

FIGS. 3A to 3C are diagrams showing use cases of the digital camera and the smart device.

FIG. 4 is a diagram showing a sequence in push sending of an image from the digital camera to the smart device according to the first embodiment.

FIGS. 5A to 5G are diagrams showing display examples of screens on the smart device and the digital camera according to first to third embodiments.

FIG. 6 is a diagram showing a sequence performed when making a remote shooting request from the smart device according to the first embodiment.

FIGS. 7A and 7B are flowcharts illustrating processing performed in the digital camera according to the first embodiment.

FIGS. 8A and 8B are flowcharts illustrating processing performed in the smart device according to the first embodiment.

FIG. 9 is a diagram showing a sequence performed when making a remote shooting end request from the smart device according to the first embodiment.

FIG. 10 is a diagram showing a sequence performed in a digital camera and a smart device according to a second embodiment.

FIG. 11 is a flowchart illustrating processing performed in the digital camera according to the second embodiment.

### DESCRIPTION OF THE EMBODIMENTS

The following describes embodiments of the present invention in detail in accordance with the drawings. It should be noted that the embodiments described below are merely exemplary means for implementing the present invention, and may be appropriately modified or changed depending on the configuration of an apparatus to which the invention is applied and various conditions. The embodiments may be also combined as appropriate.

### First Embodiment

### Internal Configuration of Digital Camera 100

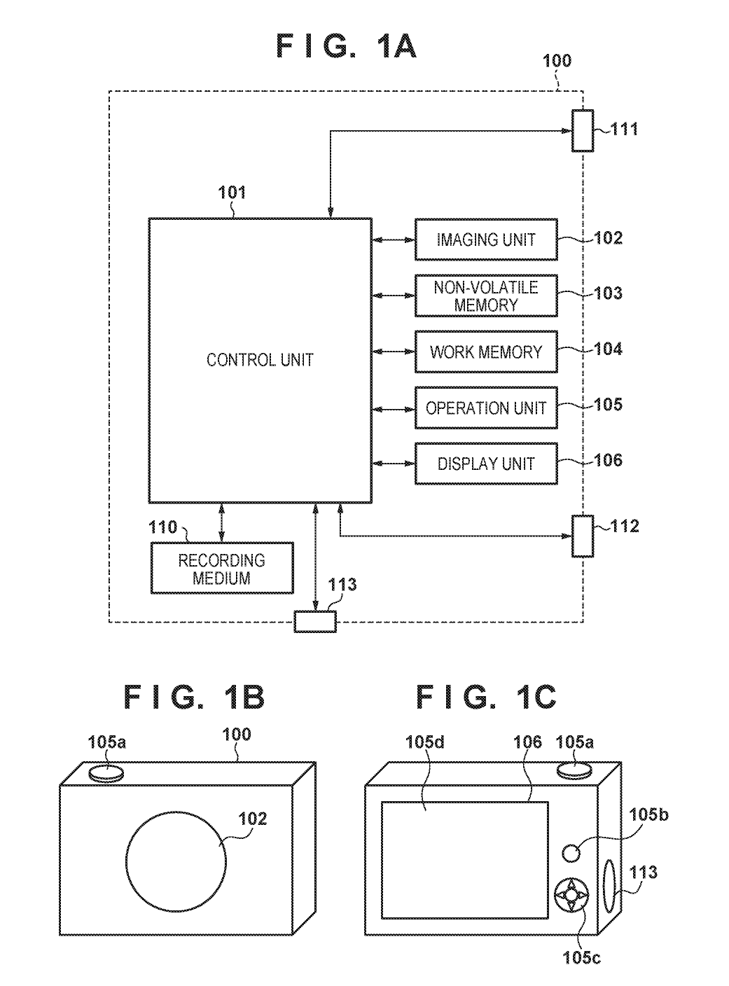

FIG. 1A is a block diagram showing an exemplary configuration of a digital camera 100 functioning as a communication apparatus (server) constituting a communication system according to the present embodiment. Note that although a digital camera in which image data can be recorded in a recording medium will be described here as an example of the communication apparatus, the communication apparatus is not limited thereto. For example, the communication apparatus may be a portable media player, a so-called tablet device, a personal computer, or an information processing apparatus that is connected to or incorporated in various facilities. In addition, data to be handled is not limited to image data, and may be audio data, document data, or the like.

A control unit 101 controls various units of the digital camera 100 in accordance with input signals and a program described below. Note that the overall apparatus may also be controlled by a plurality of pieces of hardware sharing the processing therebetween, instead of the control unit 101 controlling the overall apparatus.

An imaging unit 102 is composed of, for example, an optical lens unit, an optical system that controls a diaphragm, zooming, focusing, and the like, and an imaging element for converting light (video image) introduced through the optical lens unit into an electrical image signal. In general, a CMOS (Complementary Metal Oxide Semiconductor), a CCD (Charge Coupled Device), or the like is used as the imaging element. By being controlled by the control unit 101, the imaging unit 102 converts object light of which an image is formed by the lens included in the imaging unit 102 into an electric signal using the imaging element, performs noise reduction processing and the like, and outputs digital data as image data. In the digital camera 100 according to the present embodiment, the image data is recorded in a recording medium 110 in accordance with the DCF (Design Rule for Camera File system) standard.

A non-volatile memory 103 is an electrically erasable/recordable nonvolatile memory, and stores, for example, a program described below that is executed by the control unit 101.

A work memory 104 is used as a buffer memory that temporarily holds image data imaged by the imaging unit 102, an image display memory of a display unit 106, a work area for the control unit 101, or the like.

An operation unit 105 is used to accept an instruction given to the digital camera 100 from a user. The operation unit 105 includes, for example, a power button for allowing the user to instruct to turn ON/OFF the power supply of the digital camera 100, a release switch for instructing image capturing, and a reproduction button for instructing reproduction of image data. The operation unit 105 further includes an operation member such as a dedicated connection button for staring communication with an external device via a communication unit 111 described below. In addition, the operation unit 105 includes a touch panel formed on a display unit 106 described below. Note that the release switch is composed of a first switch and a second switch. The first switch is turned ON when the release switch is brought into the so-called half-pressed state. Consequently, an instruction to prepare image capturing, such as AF (auto focus) processing, AE (auto exposure) processing, AWB (auto white balance) processing, and EF (electronic flash preliminary emission) processing, is accepted. The second switch is turned ON when the release switch is brought into the so-called full-pressed state. Consequently, an instruction to perform image capturing is accepted.

A display unit 106 displays a viewfinder image during image capturing, captured image data, characters for interactive operations, and the like. Note that the display unit 106 may not necessarily be built into the digital camera 100. It is sufficient for the digital camera 100 to be able to connect to an internal or external display unit 106, and to include at least a display control function for controlling display of the display unit 106.

The recording medium 110 can record a plurality of imaged images obtained by being imaged by the imaging unit 102. The recording medium 110 may be configured to be removable from the digital camera 100, or may be built into the digital camera 100. That is, it is sufficient for the digital camera 100 to include at least means for accessing the recording medium 110.

A communication unit 111 is an interface for communicate with an external apparatus. The digital camera 100 according to the present embodiment can exchange data with an external apparatus via the communication unit 111. For example, image data generated by the imaging unit 102 can be sent to the external apparatus via the communication unit 111. Note that in the present embodiment, the communication unit 111 includes an interface for communicating with the external apparatus using a so-called wireless LAN in compliance with the IEEE 802.11 standard. The control unit 101 implements wireless communication with the external apparatus by controlling the communication unit 111. Note that the communication method is not limited to a wireless LAN, and includes, for example, an infrared communication method. The communication unit 111 is an example of first wireless communication means.

A short distance wireless communication unit 112 is composed of, for example, an antenna for wireless communication, and a modulation demodulation circuit and a communication controller for processing wireless signals. The short distance wireless communication unit 112 implements short distance wireless communication in compliance with the IEEE 802.15 standard (the so-called Bluetooth™) by outputting a modulated wireless signal from the antenna, and demodulating a wireless signal received by the antenna. In the present embodiment, the Bluetooth™ communication employs the Bluetooth™ Low Energy version 4.0, which has low power consumption. The Bluetooth™ communication has a narrower communicable range (i.e., has a shorter communicable distance) than the wireless LAN communication. In addition, the Bluetooth™ communication has a slower communication speed than the wireless LAN communication. On the other hand, the Bluetooth™ communication has a lower power consumption than the wireless LAN communication. The digital camera 100 according to the present embodiment can exchange data with an external apparatus via the short distance wireless communication unit 112. For example, when an image capturing command is received from the external apparatus, the digital camera 100 controls the imaging unit 102 to perform an image capturing operation. When a command for sending/receiving data via wireless LAN communication is received, the digital camera 100 controls the communication unit 111 to start wireless LAN communication.

A close proximity wireless communication unit 113 is composed of, for example, an antenna for wireless communication, and a modulation demodulation circuit and a communication controller for processing wireless signals. The close proximity wireless communication unit 113 implements non-contact close proximity communication in compliance with the ISO/IEC 18092 standard (the so-called NFC: Near Field Communication) by outputting a modulated wireless signal from the antenna, and demodulating a wireless signal received by the antenna. The close proximity wireless communication unit 113 according to the present embodiment is disposed on a side portion of the digital camera 100.

The digital camera 100 is connected to the smart device 200 by bringing the respective close proximity wireless communication units into close proximity to each other to start communication. Note that in the case of connecting the digital camera 100 and the smart device 200 by using the close proximity wireless communication units, the close proximity wireless communication units do not necessarily need to be brought into contact with each other. The close proximity wireless communication units can communicate with each other even when they are separated from each other by a certain distance. Accordingly, in order to connect the digital camera 100 and the smart device 200, it is sufficient to bring their close proximity wireless communication units close to each other to a range where close proximity wireless communication can be established. In the following description, bringing the close proximity wireless communication units to a range where close proximity wireless communication can be established is also referred to as bringing them into close proximity.

Communication will not be started when the respective close proximity wireless communication units of the digital camera 100 and the smart device 200 are within a range where close proximity wireless communication cannot be established. When the respective close proximity wireless communication units of digital cameras 100 are in a range where close proximity wireless communication can be established, and communication connection is established between the digital cameras 100, the communication connection is released if their respective close proximity wireless communication units 113 are separated from each other to a range where close proximity wireless communication cannot be established. Note that the non-contact close proximity communication implemented by the close proximity wireless communication unit 113 is not limited to NFC, and another wireless communication may be employed. For example, a non-contact close proximity communication in compliance with the ISO/IEC 14443 standard may be employed as the non-contact close proximity communication implemented by the close proximity wireless communication unit 113.

In the present embodiment, the communication speed of communication implemented by the communication unit 111 is faster than the communication speed of communication implemented by a close proximity wireless communication unit 113 described below. In addition, communication implemented by the communication unit 111 has a wider communicable range than communication implemented by the close proximity wireless communication unit 113. Instead, communication implemented by the close proximity wireless communication unit 113 can limit the other communication party due to the narrowness of the communicable range, and thus does not require processing, such as exchanging of a cryptographic key, required for communication implemented by the communication unit 111. That is, communication can be more easily performed than by using the communication unit 111.

Note that the communication unit 111 of the digital camera 100 according to the present embodiment has an AP mode in which the communication unit 111 operates as an access point in an infrastructure mode, and a CL mode in which the communication unit 111 operates as a client in the infrastructure mode. Then, by causing the communication unit 111 to operate in the CL mode, the digital camera 100 according to the present embodiment can operate as a CL device in the infrastructure mode. When the digital camera 100 operates as the CL device, the digital camera 100 can participate in a network formed by the AP device by connecting to a peripheral AP device. By causing the communication unit 111 to operate in the AP mode, the digital camera 100 according to the present embodiment can operate as a simplified AP (hereinafter referred to as a “simple AP”), which is one type of AP but has more limited functions. When the digital camera 100 operates as the simple AP, the digital camera 100 forms a network by itself. A peripheral apparatus of the digital camera 100 recognizes the digital camera 100 as the AP device, and can participate in the network formed by the digital camera 100. It is assumed that a program for causing the digital camera 100 to operate in the above-described manner is held in the non-volatile memory 103.

Note that the digital camera 100 according to the present embodiment is one type of AP, but is a simple AP that does not have a gateway function for transferring the data received from the CL device to an Internet service provider or the like. Therefore, even when the digital camera 100 receives data from another apparatus participating in the network formed by the digital camera 100, the digital camera 100 cannot transfer the data to a network such as the Internet.

Next, the external appearance of the digital camera 100 will be described. FIGS. 1B and 1C are diagrams showing an example of the external appearance of the digital camera 100. A release switch 105a, a reproduction button 105b, a direction key 105c, and a touch panel 105d are operation members included in the operation unit 105 described above. An image obtained as the result of imaging performed by the imaging unit 102 is displayed on the display unit 106. The digital camera 100 according to the present embodiment includes an antenna portion of the close proximity wireless communication unit 113 on a side surface of a camera casing. By bringing the close proximity wireless communication units 113 close to each other at a certain distance, close proximity wireless communication with another device can be established. Accordingly, communication can be performed contactlessly not via a cable or the like, and the other communication party can be limited in accordance with the user's intention. The foregoing has described the configuration of the digital camera 100 according to the embodiment.

Internal Configuration of Smart Device 200

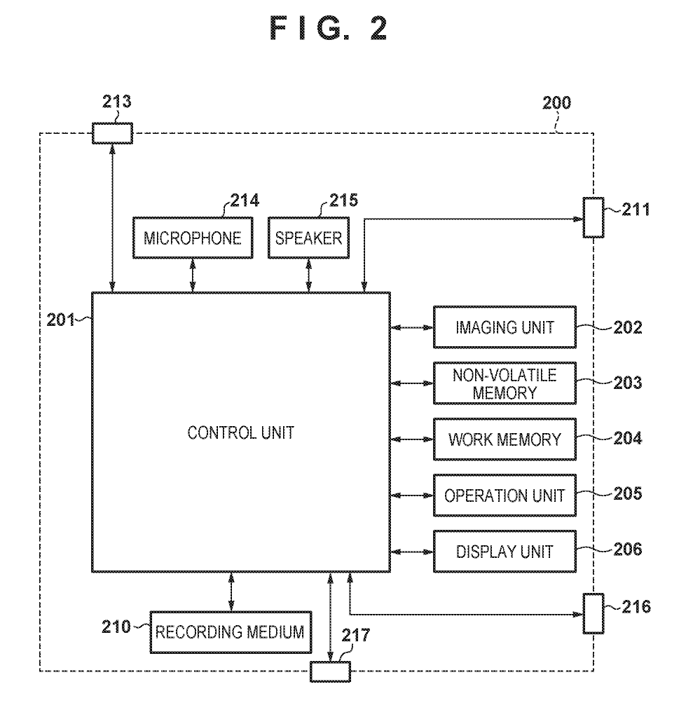

FIG. 2 is a block diagram showing an exemplary configuration of a smart device 200, which is an example of a terminal apparatus (information processing apparatus) constituting the communication system according to the present embodiment. Although a smart device will be described as an example of the information processing apparatus here, the information processing apparatus is not limited thereto. For example, the information processing apparatus may be a wireless-enabled digital camera, tablet device, or personal computer.

A control unit 201 controls various units of the smart device 200 in accordance with input signals and a program described below. Note that the overall apparatus may also be controlled by a plurality of pieces of hardware sharing the processing therebetween, instead of the control unit 201 controlling the overall apparatus.

An imaging unit 202 converts object light of which an image is formed by a lens included in the imaging unit 202 into an electric signal, performs noise reduction processing and the like, and outputs digital data as image data. The imaged image data is accumulated in a buffer memory, which is then subjected to a predetermined arithmetic operation by the control unit 201, and is recorded in a recording medium 210.

A non-volatile memory 203 is electrically erasable/recordable nonvolatile memory. In the non-volatile memory 203, an OS (operating system) serving as basic software executed by the control unit 201, and an application that implements applied functions in cooperation with the OS are recorded. In the present embodiment, the non-volatile memory 203 stores an application (hereinafter referred to as an “app”) for communicating with the digital camera 100.

A work memory 204 is used as an image display memory for a display unit 206, a work area for the control unit 201, or the like.

An operation unit 205 is used to accept an instruction to the smart device 200 from the user. The operation unit 205 includes, for example, a power button for the user to instruct to turn ON/OFF of the power supply of the smart device 200, and an operation member such as a touch panel formed on the display unit 206.

A display unit 206 displays image data, characters for interactive operation, and the like. Note that the display unit 206 does not necessarily need to be included in the smart device 200. It is sufficient for the smart device 200 to be able to connect to the display unit 206, and to include at least a display control function for controlling the display of the display unit 206.

A recording medium 210 can record image data output from the imaging unit 202. The recording medium 210 may be configured to be removable from the smart device 200, or may be built into the smart device 200. That is, it is sufficient for the smart device 200 to include at least means for accessing the recording medium 210.

A communication unit 211 is an interface for connecting to an external apparatus. The smart device 200 according to the present embodiment can exchange data with the digital camera 100 via the communication unit 211. In the present embodiment, the communication unit 211 is an antenna, and the control unit 201 can connect to the digital camera 100 via the antenna. Note that a connection to the digital camera 100 may be established directly, or may be established via an access point. As a protocol for communicating data, PTP/IP (Picture Transfer Protocol over Internet Protocol) over a wireless LAN can be used, for example. Note that communication with the digital camera 100 is not limited thereto. For example, the communication unit 211 may include a wireless communication module such as an infrared communication module, or a Wireless USB. Furthermore, a wired connection such as a USB cable, HDMI, or IEEE 1394 may be employed.

A public network connecting interface 213 is an interface used for performing public wireless communication. The smart device 200 can make a call to another device via the public network connecting interface 213. At this time, the control unit 201 implements a call by inputting/outputting audio signals via a microphone 214 and a speaker 215. In the present embodiment, the public network connecting interface 213 is an antenna, and the control unit 201 can connect to a public network via the antenna. Note that one antenna can be used for both the communication unit 211 and the public network connecting interface 213.

A short distance wireless communication unit 216 is composed of, for example, an antenna for wireless communication, and a modulation demodulation circuit and a communication controller for processing wireless signals. The short distance wireless communication unit 216 implements short distance wireless communication in compliance with the IEEE 802.15 standard (the so-called Bluetooth™) by outputting a modulated wireless signal from the antenna, and demodulating a wireless signal received via the antenna. In the present embodiment, the Bluetooth™ communication employs the Bluetooth™ Low Energy version 4.0 (BLE), which has low power consumption. This Bluetooth™ communication has a narrower communicable range (i.e., a shorter communicable distance) than wireless LAN communication. In addition, the Bluetooth™ communication has a slower communication speed than wireless LAN communication. On the other hand, the Bluetooth™ communication has a lower power consumption than wireless LAN communication.

A close proximity wireless communication unit 217 is a communication unit for implementing non-contact close proximity communication with another device. The close proximity wireless communication unit 217 is composed of an antenna for wireless communication, and a modulation demodulation circuit and a communication controller for processing wireless signals. The close proximity wireless communication unit 217 implements non-contact close proximity communication by outputting a modulated wireless signal from the antenna, and demodulates a wireless signal received via the antenna. Here, non-contact communication in compliance with the ISO/IEC 18092 standard (the so-called NFC) is implemented. Upon reception of a data read-out request from another device, the close proximity wireless communication unit 217 outputs response data based on the data stored in the non-volatile memory 203. In the present embodiment, the smart device 200 operates in a card reader mode, a card writer mode, and a P2P mode, which are defined in the NFC standards, via the close proximity wireless communication unit 217, and mainly acts as an Initiator. In contrast, the digital camera 100 mainly acts as a Target via the close proximity wireless communication unit 113. The foregoing has described the configuration of the smart device 200 according to the embodiment.

Description of Concept of Pull Sending, Push Sending, and Remote Shooting

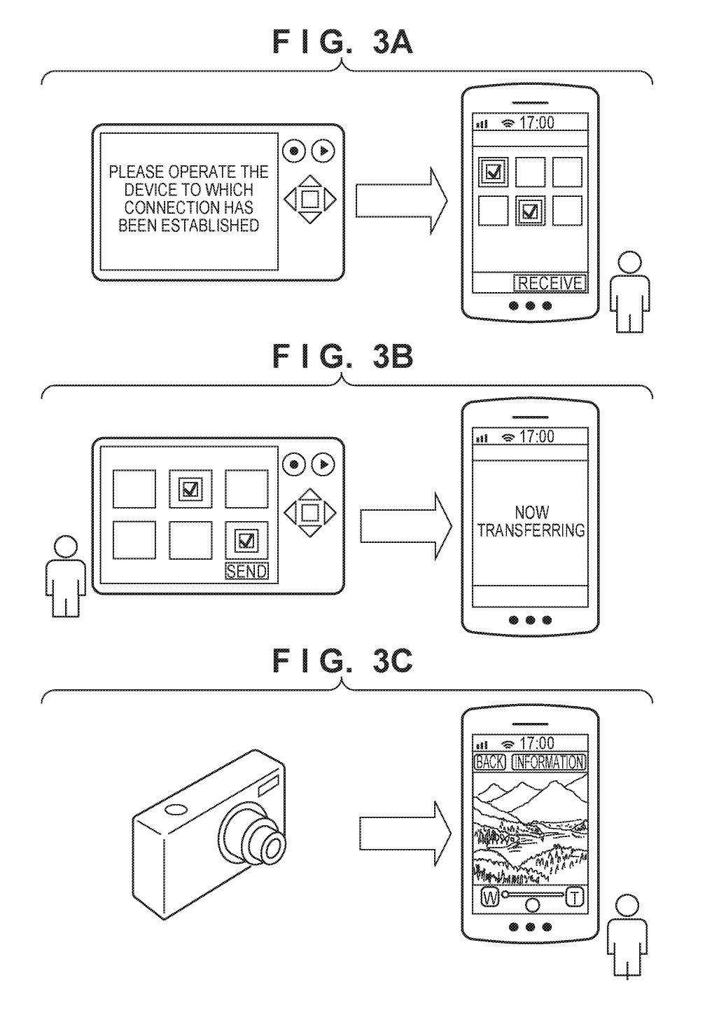

FIGS. 3A to 3C show images for illustrating sending modes different from each other. A description will be given of the difference between the sending modes in the sending method used for sending a file saved in a server device to a client device.

FIG. 3A shows an image when the sending mode is pull sending. In pull sending, the user selects a file to be sent at the client device. The client device makes a request for the file selected by the user to the server device, and the server device sends the requested file to the client device.

FIG. 3B shows an image when the sending mode is push sending. In push sending, the user selects a file to be sent at the server device. The client device makes a sending file acquisition request to the server device in order to acquire the file selected at the server device. The server device selects a file to be sent, and, upon completion of selection, sends information on the file to be sent for an acquisition request for the selected file. The client device requests the file selected in the server device, and the server device sends the requested file.

FIG. 3C shows an image showing remote shooting. Remote shooting is a mode in which the client device is operated to cause the server device to operate. In order for a live-view image of the server device to be displayed on the client device, the client device periodically makes a live view acquisition request to the server device, and the server device sends a live view to the client device. By making a setting change request and an image shooting request from the client device, it is possible to change the settings and perform image shooting at the server device.

In the present embodiment, a description is given assuming that the digital camera 100 is the server device and the smart device 200 is the client device.

Problem in Performing Push Sending from Digital Camera 100 to Smart Device 200 and Method for Solving the Problem

In order to perform push sending of an image from the digital camera 100 to the smart device 200 as shown in FIG. 3B, a list of images selected at the digital camera 100 needs to be sent to the smart device 200. The smart device 200 that has received the image list achieves push sending of an image by requesting and acquiring the image from the digital camera 100. However, in the case of a request/response communication protocol such as HTTP, the list of selected images cannot be voluntarily sent from the digital camera 100 operating as a server to the smart device 200 operating as a client. To solve this problem, it is necessary to achieve voluntary sending from the server side (server push).

Therefore, in the present embodiment, a technique called long polling is used to achieve an emulated server push. In long polling, first, a request is sent from the client, and the server intentionally holds a response to that request. Then, the server sends the held response to the request at given timing for performing some notification. Doing so makes it possible to achieve, in an emulated manner, a so-called server push in which data is sent from the server to the client at given timing.

In the present embodiment, the above-described long polling is applied to the system shown in FIG. 3B. To send the list of images selected at the digital camera 100 to the smart device 200 at given timing, a long polling request is sent from the smart device 200 to the digital camera 100. The digital camera 100 that has received the long polling request temporarily places this request in a holding state, and accepts selection of an image made by the user during this period. Then, at the time of starting push sending after the user has selected images, the digital camera 100 sends a list of the selected images to the smart device 200 as a response to the long polling request. The smart device 200 that has received the response achieves push sending by requesting and acquiring the images of the received image list from the digital camera 100. In the above-described example, the smart device 200 cannot predict when the image selection performed by the user will be completed. Therefore, a configuration in which the digital camera 100 voluntarily sends the image list to the smart device 200 after the image selection is suitable.

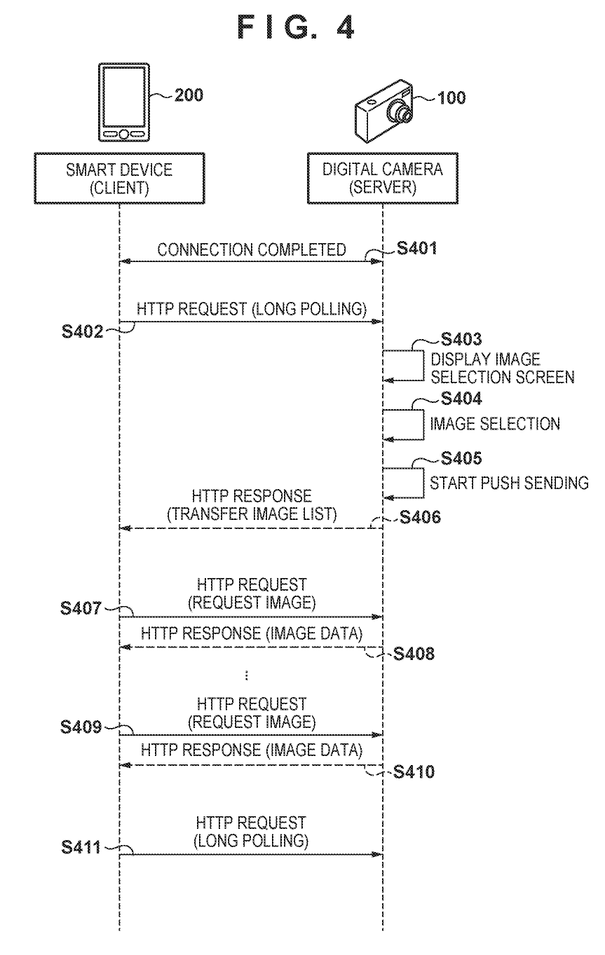

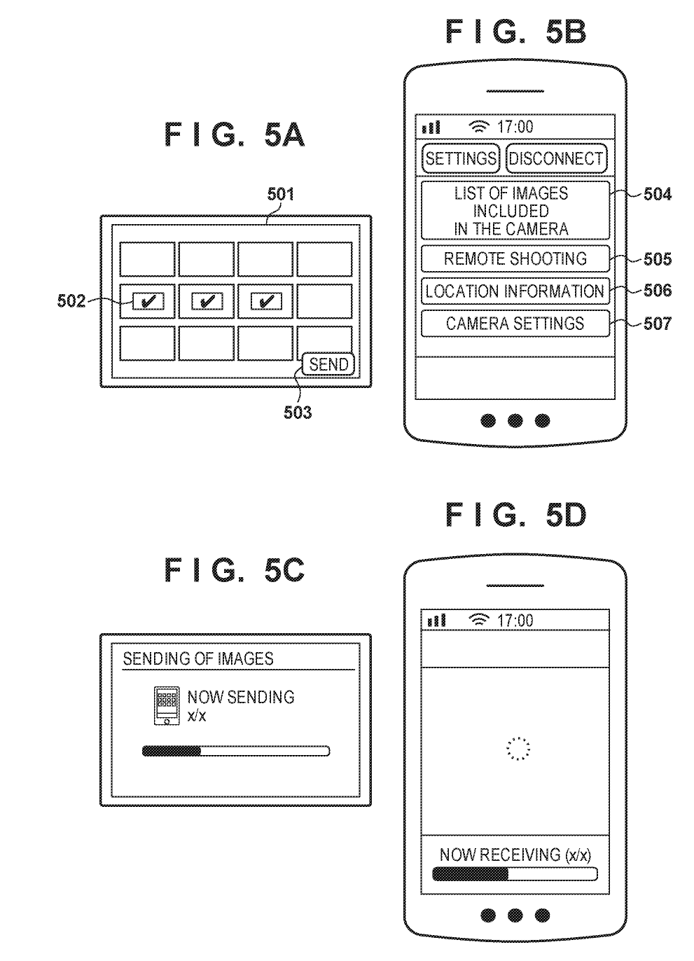

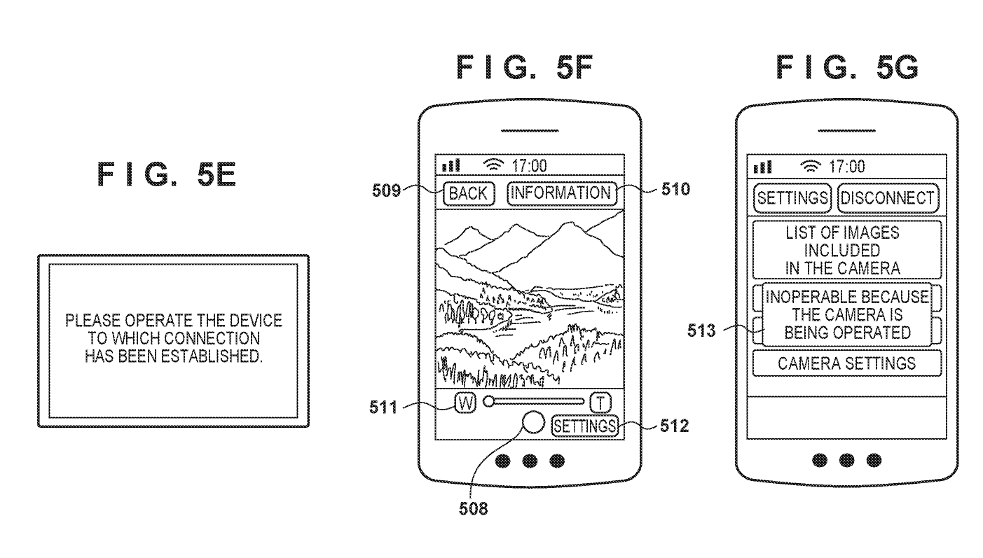

In the following, a flow of processing performed at the time of sending an image by push sending to the smart device 200 by operating the digital camera 100 will be described with reference to FIG. 4 and FIGS. 5A to 5G. FIG. 4 is a diagram showing a sequence performed at the time of sending an image by push sending from the digital camera 100 to the smart device 200. FIGS. 5A to 5G are diagrams showing exemplary screens of the digital camera 100 and the smart device 200.

First, in step S401, the digital camera 100 and the smart device 200 make a Wi-Fi connection, discover each other using a device discovering protocol, and make a protocol connection for performing data communication, thereby completing connection therebetween. Examples of the protocol for performing data communication include HTTP. It is assumed that the digital camera 100 operates as an HTTP server and the smart device 200 operates as an HTTP client in the present embodiment.

Next, in step S402, the smart device 200 serving as a client sends a long polling request to the digital camera 100. To differentiate a long polling request from a regular request, it is possible to add a specific argument or flag to a request command, or prepare a separate request command, for example.

In step S403, the digital camera 100 that has received the long polling request displays an image selection screen for allowing the user to select an image to be sent by push sending to the smart device 200. As indicated by reference numeral 501 in FIG. 5A, the digital camera 100 displays a list for images saved in the recording medium 110. As shown in FIG. 5B, the smart device 200 displays an operation menu. Then, as indicated by reference numerals 504 to 507, menu items such as “List of images included in the camera”, “Remote shooting”, “Location information”, and “Camera settings” can be operated. When any of operation buttons with numerals 504 to 507 is depressed, processing corresponding to the depressed button is executed. Here, in the description, it is assumed that the user does not operate the smart device 200.

Note that when “List of images included in the camera” is operated, the smart device 200 requests and acquires information indicating a list of the images stored in the storage medium 110 of the digital camera 100. The list is in the form of image file names with thumbnails (or IDs specifying image files). When “Remote shooting” is operated, the smart device 200 remotely operates the imaging unit 102 of the digital camera 100. When “Location information” is operated, the smart device 200 attaches (writes) location information of a GPS (not shown) included in the smart device 200 to the user-selected images stored in the digital camera 100. When “Camera settings” is operated, the user operates the smart device 200 to set various operating environments in the digital camera 100. The setting content includes the time and date setting of a timer, the ISO sensitivity, and the like in the digital camera 100.

Next, in step S404, the control unit 101 of the digital camera 100 accepts selection of images to be sent by push sending to the smart device 200 by the user via the operation unit 105. When the user selects an image to be sent, the control unit 101 displays a check mark indicating that the image has been selected, as indicated by reference numeral 502 in FIG. 5A.

Then, when the control unit 101 detects a sending instruction given by the user (detects depression of a send button 503), the control unit 101 shifts to send processing from the digital camera 100 to the smart device 200 in step S405. Accordingly, in step S406, the control unit 101 sends a list of the images selected by the user in step S404 to the smart device 200 as a response to the long polling request. An ID list specifying the selected images or a list of path names including image files is described in the image list.

Next, in step S407, the smart device 200 refers to the image list received in step S406, and sends an image acquisition request to the digital camera 100 by using the ID or path name of one image described in the image list.

In step S408, the digital camera 100 acquires the image specified by the image acquisition request received from the digital camera 100 from the recording medium 110, and sends the image to the smart device 200.

Thereafter, the smart device 200 makes an image acquisition request (S409) to the digital camera 100 for the number of times equal to the number of the images included in the image list received in step S406, and the digital camera 100 performs processing corresponding to the requests (S410).

Examples of the screens on the digital camera 100 and the smart device 200 while images are being sent are shown in FIGS. 5C and 5D, respectively. The control unit 101 of the digital camera 100 can know the total number of the selected images, and can also know the number of the image that is currently being sent since the image list has been sent. Therefore, the control unit 101 can display a progress state as shown in the drawing. The control unit 201 of the smart device 200 can also know the total number of images that should be acquired from the received image list, and sequentially requests the images described in the list. Accordingly, the control unit 201 can display a progress bar indicating the state of reception of the images, as shown in FIG. 5D.

Upon reception of all the images included in the image list received in step S406 from the digital camera 100, in step S411, the smart device 200 sends a long polling request to the digital camera 100 again. The digital camera 100 that has received the long polling request displays an image selection screen so as to allow the user to make an image selection as in step S403. After completion of sending of the images, the screens of the digital camera 100 and the smart device 200 return to the screens displayed before sending of the images, as shown in FIGS. 5A and 5B, respectively.

As described above, the digital camera 100 includes the image list selected by the user in the response to the long polling request from the smart device 200. Accordingly, images can be sent by push sending from the digital camera 100 to the smart device 200.

Here, it is conceivable that the user operates the smart device 200 during a period from when the smart device 200 has sent a long polling request to the digital camera 100 until a response (image list) to the long polling request is returned.

For example, connection between the digital camera 100 and the smart device 200 is completed, and the smart device 200 sends a long polling request to the digital camera 100. Thereby, the digital camera is brought into a state in which image selection can be performed at the digital camera 100. It is assumed that the user subsequently operates (depresses) a remote shooting button 505 in FIG. 5B from the menu displayed on the smart device 200. In this case, the smart device 200 sends a transition request to remote shooting to the digital camera 100, and the digital camera 100 transitions to a remote shooting state.

However, if the digital camera 100 receives a remote shooting transition request and transitions to the remote shooting state in a state in which the digital camera 100 has not returned a response after receiving a long polling request from the smart device 200, there is the problem that the resource for maintaining long polling is continuously used.

Therefore, the digital camera 100 according to the embodiment is configured to, when “another request” is received from the smart device 200 in a state in which a response to a long polling request from the smart device 200 has not been returned, return a cancellation response to the long polling request, and thereafter performs the processing for “another request”. In the following, this will be described using a specific example.

Transition from Push Sending to Remote Shooting

With reference to FIGS. 5A to 8B, the processing performed when transitioning to remote shooting by operating the smart device 200 after establishing connection between the digital camera 100 and the smart device 200 will be described.

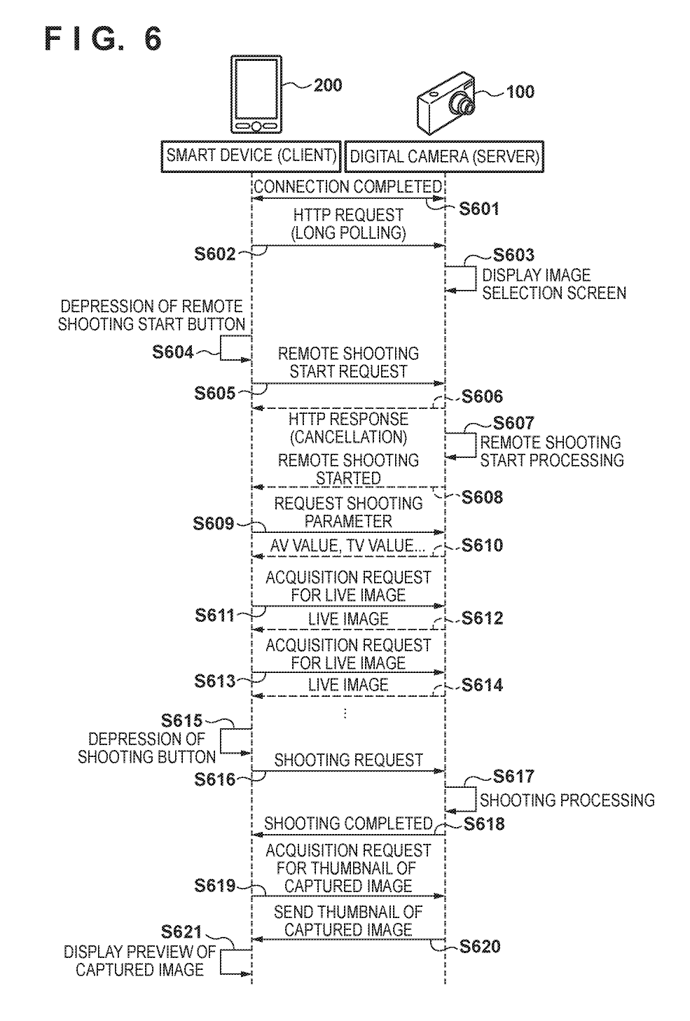

FIG. 6 is a diagram showing a sequence performed when transitioning to remote shooting by operating the smart device 200 after establishing connection between the digital camera 100 and the smart device 200. In the following, a description will be given with reference to the drawing.

First, in step S601, the digital camera 100 and the smart device 200 make a Wi-Fi connection, discover each other using a device discovering protocol, and make a protocol connection for performing data communication, thereby completing connection therebetween. As described above, examples of the protocol for performing data communication include HTTP. The digital camera 100 operates as a server, and the smart device 200 operates as a client.

Next, in step S602, the smart device 200 sends a long polling request to the digital camera 100.

The digital camera 100 that has received the long polling request displays, in step S603, an image selection screen so as to allow the user to select images to be sent. As indicated by reference numeral 501 in FIG. 5A, the digital camera 100 displays a selection screen for the saved images. When the user selects an image to be sent, a check mark is displayed as indicated by reference numeral 502 in FIG. 5A, so that sending of the image can be started when the user selects the send button 503. Here, it is assumed that the user has not depressed the send button 503 shown in FIG. 5A, or in other words, has not started sending of the image.

In this situation, the smart device 200 displays the operation menu as shown in FIG. 5B after completion of establishing connection to the digital camera 200. As indicated by reference numerals 504 to 507 shown in the drawing, this menu includes menu items (processing items) such as “List of images included in the camera”, “Remote shooting”, “Location information”, and “Camera settings”. By depressing any of the operation buttons 504 to 507, the user can cause the processing corresponding to the depressed button to be executed. Here, it is assumed that depression of the remote shooting button 505 by the user is detected in S604. In this case, in step S605, the smart device 200 sends a remote shooting start request to the digital camera 100.

Next, in step S606, the digital camera 100 sends, to the smart device 200, a cancellation response to the long polling request received in step S602. This processing is intended to prevent wasteful use of the resource for maintaining long polling since it is not necessary to respond to the long polling request during remote shooting.

In step S607, the digital camera 100 performs processing for transitioning to a remote shooting operation. The processing for transitioning to the remote shooting operation is, for example, processing for extending the lens barrel so as to be able to capture an image with the digital camera. Upon completion of the processing for transitioning to the remote shooting operation, the digital camera 100 displays a message indicating that the digital camera 100 is inoperable, such as “Please operate the device to which connection has been established”, as shown in FIG. 5E.

Next, in step S608, the digital camera 100 notifies the smart device 200 that the processing for transitioning to the remote shooting operation is completed and the operation has transitioned to remote shooting operation.

Next, in step S609, the smart device 200 sends, to the digital camera 100, an acquisition request for a parameter that can be set in the digital camera 100, such as a shooting parameter. The shooting parameter is, for example, an aperture value (Av), a shutter speed (Tv), an ISO sensitivity, or the like. In step S610, for this request, the digital camera 100 sends, to the smart device 200, information on a shooting parameter that can be set in the digital camera 100 such as an Av value, a Tv value, or an ISO sensitivity.

Next, in step S611, the smart device 200 sends an acquisition request for a live image to the digital camera 100. In step S612, the digital camera 100 sends, to the device 200, a live image captured with the digital camera.

As shown in steps S613 and S614, by repeating the same processing as those performed in steps S611 and S612, the smart device 200 can display a live image by periodically acquiring an image captured with the digital camera 100. FIG. 5F shows a display example of a live image of the display unit 206 of the smart device 200 during this period. Note that while a live image is being transferred, an image obtained by thinning an image imaged with the imaging unit 102 into a preset resolution is subjected to sending. As an operation performed in the smart device 200 during remote shooting, a high-resolution image can be captured with the digital camera 100 by depressing a shooting button 508 shown in FIG. 5F. Remote shooting can be ended by depressing a back button 509 shown in FIG. 5F. Information on the shooting parameter or the like of the digital camera 100 can be displayed on the screen by depressing an information button 510 shown in FIG. 5F. The angle of view of the digital camera 100 can be adjusted by operating a zoom button 511 shown in FIG. 5F. The shooting parameter or the like of the digital camera 100 can be set by depressing a setting button 512 shown in FIG. 5F.

Next, it is assumed that, in step S615, the control unit 201 of the smart device 200 detects depression of the shooting button 508 shown in FIG. 5F through the operation unit 205. In this case, in step S616, the smart device 200 sends a shooting request to the digital camera 100.

Next, in step S617, the digital camera 100 performs imaging processing of a high-resolution image using the imaging unit 202, and saves the captured image in the recording medium 210. Next, in step S618, the digital camera 100 sends a notification indicating completion of shooting to the smart device 200 as a response to the request sent in S616.

Next, in step S619, the smart device 200 makes an acquisition request for a thumbnail of the captured image to the digital camera 100. Next, in step S620, the digital camera 100 sends the thumbnail of the captured image to the smart device 200.

Next, in step S621, the smart device 200 displays a preview of the thumbnail received in step S620 on the screen, thus allowing the user to confirm the captured image.

As described above, the digital camera 100 and the smart device 200 transition to the remote shooting state, and perform processing for remote shooting.

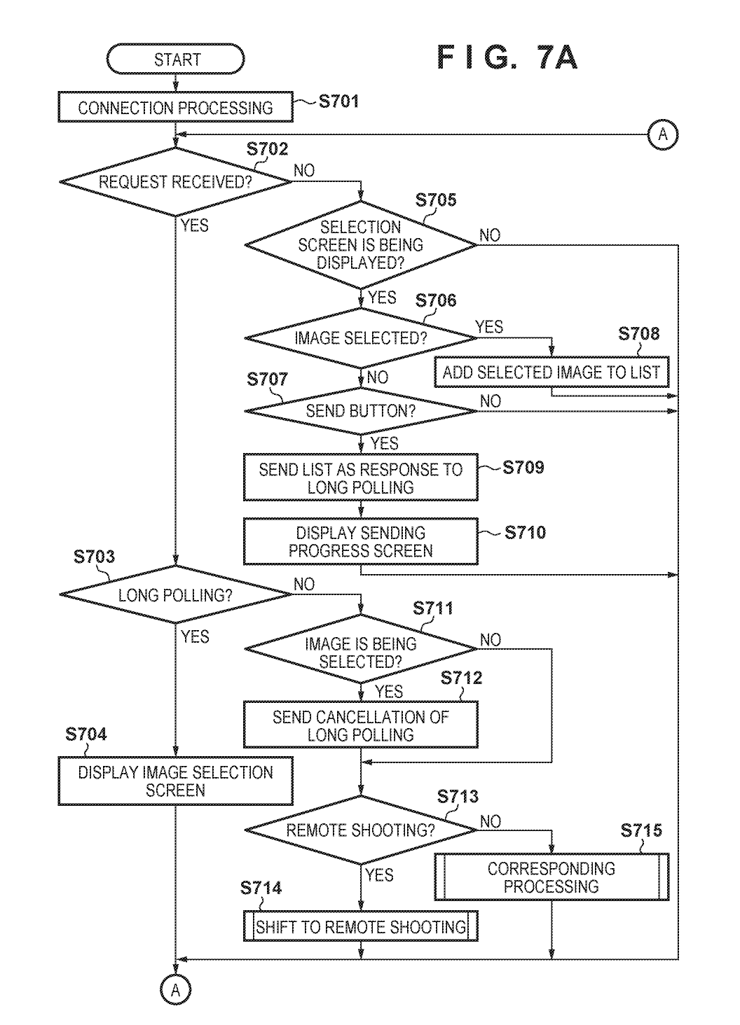

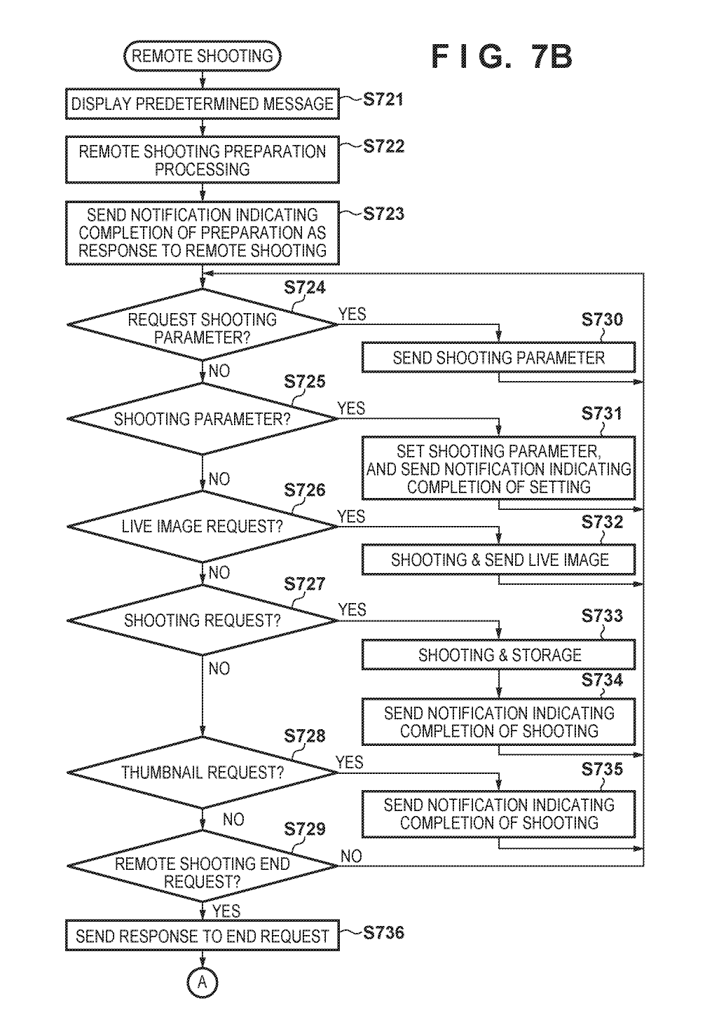

Next, the processing performed in the digital camera 100 according to the embodiment will be described with reference to FIGS. 7A and 7B. Note that a program according to the drawing is stored in the non-volatile memory 103. Then, when power is turned on, the control unit 101 of the digital camera 100 loads the program stored in the non-volatile memory 103 into the work memory 104, and executes the program.

First, in step S701, the control unit 101 performs processing for connecting to the smart device 200 via the communication unit 111, and, when the connection is completed, advances the processing to step S702.

In step S702, the control unit 101 determines whether any request is received from the smart device 200. If not, the control unit 101 determines, in step S705, whether a list screen (see FIG. 5A) of images selectable by the user is being displayed. Since the display of the list screen of images is performed in step S704 described later, it is assumed that the list screen of images is not displayed here. Accordingly, the processing returns to S702, in which the control unit 101 will wait for a request from the smart device 200.

Meanwhile, if it is determined that some request is received from the smart device 200, the control unit 101 advances the processing from step S702 to step S703. In S703, the control unit 101 determines whether the received request is a long polling request. If it is a long polling request, the control unit 101 advances the processing to step S704, in which the image selection screen 501 (FIG. 5A) is displayed, and the control unit 101 returns the processing to step S702.

Since the image selection screen is displayed in step S704, the result of determination in step S705 will be Yes, and the presence of an operation input from the user and the type thereof will be determined in steps S706 and S707. That is, in steps S706 and S707, the control unit 101 determines which of an image selection operation and an operation of the send button 503 is performed on the image selection screen 501. If neither of the operations is performed, the control unit 101 returns the processing to step S702. If an image selection by the user is performed through the image selection screen 501, the control unit 101 advances the processing from step S706 to step S708. In step S708, the control unit 101 additionally writes, in the list reserved in the work memory 104 in advance, information specifying the selected image (e.g., a file name with the path name of a storage location in the recording medium 110), and returns the processing to S702. By repeating this, the user can select as many images as desired. If the user operation is depression of the send button 503, the control unit 101 advances the processing from step S707 to step S709. In step S709, the control unit 101 converts the list built in the work memory 104 into a suitable format, and sends the converted list to the smart device 200 as a response to the long polling request. The smart device 200 that has received the list will make a sending request for each of the images described in the list. Thus, in step S710, the control unit 101 displays a sending progress screen indicating the progress of sending (FIG. 5C) in place of the image selection screen, and returns the processing to step S702. Note that if the sending progress screen is displayed, the result of determination in step S703 is No, and the determination of the presence of an operation input by the user will not be performed.

Meanwhile, if it is determined in step S703 that the request determined to be received in step S702 is a request other than long polling, the control unit 101 advances the processing to step S711.

In step S711, the control unit 101 determines whether the image selection screen 501 is being displayed, or in other words, whether an image is being selected by the user. A situation where the image selection screen is being displayed means that the digital camera 100 has yet to send a response to the long polling request from the smart device 200. Thus, in step S712, the control unit 101 sends a cancellation response as a response to the long polling request to the smart device 200 via the communication unit 111, and advances the processing to step S713.

In step S713, the control unit 101 determines whether the request determined to be received in S702 is a remote shooting request. This corresponds to determining whether the user has operated the operation button 505 in FIG. 5B displayed on the smart device 200.

If the received request is a remote shooting request, the control unit 101 advances the processing to step S714, and shifts to remote shooting processing. On the other hand, if a request other than the remote shooting request is received, the control unit 101 performs the corresponding processing in step S715, and performs processing for sending the result thereof as a response. Note that the reception of an image sending request from the smart device 200 and the image send processing (S407 and S408 in FIG. 4) after the digital camera 100 has sent the image list to the smart device 200 are also performed in step S715.

FIG. 7B is a flowchart illustrating the details of step S714. In the following, the remote shooting processing according to the embodiment will be described with reference to the drawing.

First, in step S721, the control unit 101 displays a message indicating that the operation has shifted to remote shooting by the smart device 200, as shown in FIG. 5E. Then, in step S722, the control unit 101 performs processing for preparing remote shooting (starting driving of the imaging unit 101). Then, in step S723, the control unit 101 sends a notification indicating that the preparation for remote shooting is completed as a response to the remote shooting request to the smart device 200.

Thereafter, as will be described below, the control unit 101 waits for a further request from the smart device in steps S724 to S729, and performs processing corresponding to that request in steps S730 to S735.

If the received request is a shooting parameter request, the control unit 101 advances the processing from step S724 to step S730. In step S730, the control unit 101 acquires, from the imaging unit 102, a shooting parameter that can be currently set, and sends that shooting parameter as a response to the request to the smart device 200 via the communication unit 111, and returns the processing to step S724.

If the received request is a setting request for a shooting parameter such as a zoom magnification, the control unit 101 advances the processing from step S725 to step S731. In step S731, the control unit 101 sets the parameter that has been set for the imaging unit 102, sends a notification indicating completion of setting to the smart device 200 as a response to the request, and returns the processing to step S724.

If the received request is a request for a live image, the control unit 101 advances the processing from step S726 to step S732. In step S732, the control unit 101 performs imaging processing with the imaging unit 102, and generates an image that has been thinned into a preset resolution. Then, the control unit 101 sends the generated image to the smart device 200 as a response to the request for a live image, and returns the processing to step S724.

If the received request is a shooting request (corresponding to depression of the shooting button 508 in FIG. 5F), the control unit 101 advances the processing from step S727 to step S733. In step S733, the control unit 101 performs imaging processing with the imaging unit 102, and stores the resulting image as high-resolution image data in the recording medium 110. Then, in step S734, the control unit 101 sends a notification indicating shooting completion to the smart device 200 as a response to the shooting request, and return the processing to step S724.

If the received request is a request for a thumbnail, the control unit 101 advances the processing from step S728 to step S735. In step S735, the control unit 101 generates a thumbnail of the most recently captured image stored in the recording medium 110, and sends the generated thumbnail to the smart device 200 as a response to the thumbnail request, and returns the processing to step S724.

If the received request is an end request for remote shooting (corresponding to an operation of “Back” button 509 in FIG. 5F), the control unit 101 advances the processing from step S729 to S736. In step S736, the control unit 101 sends a response indicating that the end request is accepted to the smart device 200. Then, the control unit 101 returns the processing to step S702.

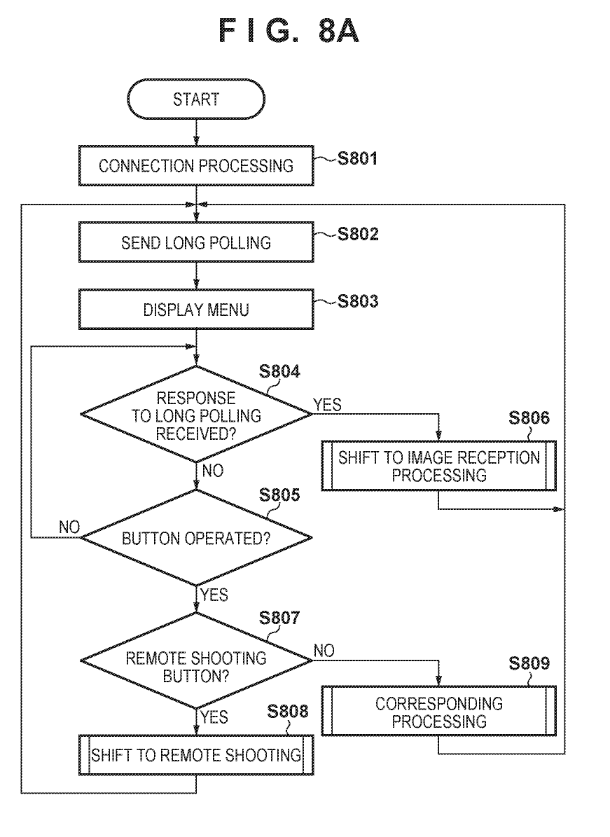

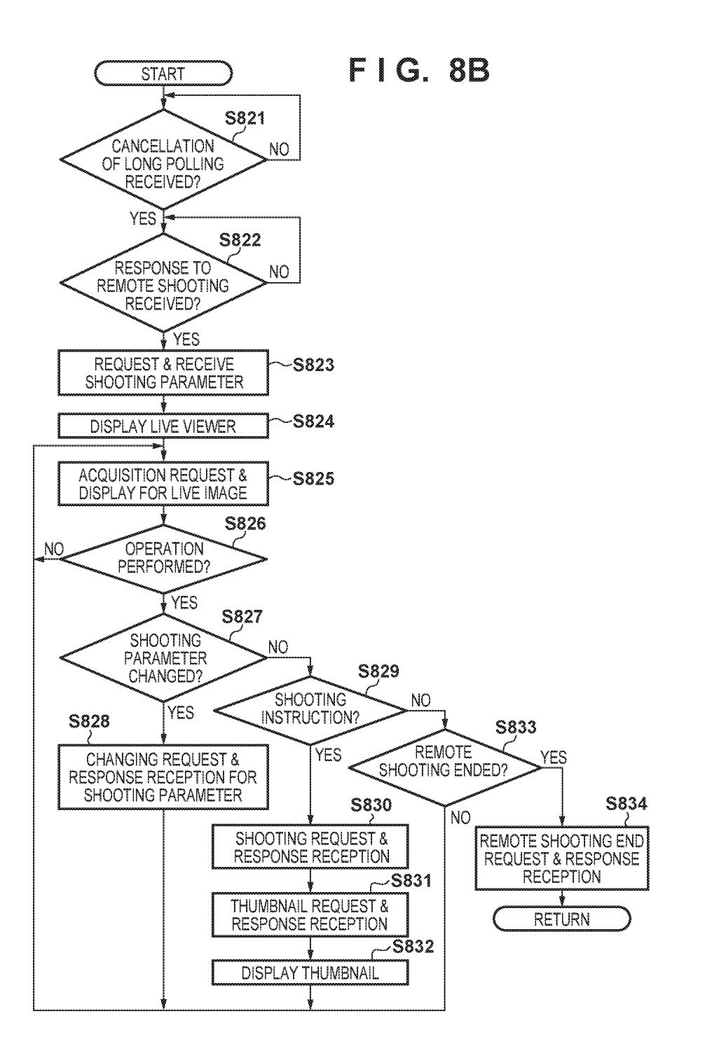

Next, communication processing performed in the smart device 200 according to the embodiment will be described with reference to FIG. 8A. A program according to the drawing is stored in the non-volatile memory 203. Then, the communication processing is implemented by the control unit 201 loading the program stored in the non-volatile memory into the work memory 204, and executing the program.

First, in step S801, the control unit 201 performs processing for connecting to the digital camera 100 via the communication unit 211, and, upon completion of the connection processing, advances the processing to step S802. Step S801 corresponds to step S601 in FIG. 6.

Next, in step S802, the control unit 201 sends a long polling request to the digital camera 100 via the communication unit 211, and advances the processing to step S803. Step S802 corresponds to step S602 in FIG. 6.

Next, in step S803, the control unit 201 displays a menu screen for communication with the digital camera 100 on the display unit 206 (see FIG. 5B).

Thereafter, in the loop of steps S804 and S805, the control unit 201 waits for a response from the digital camera 100 to the previously sent long polling, or input of an instruction to the display menu from the user via the operation unit 205.

If a response to the long polling is received from the digital camera 100, the control unit 201 advances the processing to step S806. In step S806, the control unit 201 repeats a request for all the images described in the selected image list, which is a response to the long polling, and processing for receiving and storing the images. Such processing corresponds to steps S407 to S410 in FIG. 4.

If a response to the long polling is received from the digital camera 100, the control unit 201 advances the processing from step S804 to step S806. In step S806, the control unit 201 requests each of the images described in the selected image list included in the response to the long polling, and processing for receiving the image and storing the image in the non-volatile memory 203 or the recording medium 210. After completing the processing for receiving and storing all the images, the control unit 201 returns the processing to step S802.

On the other hand, if an instruction for the menu displayed on the display unit 206 is input, the control unit 201 advances the processing from step S805 to step S807. In step S807, the control unit 201 determines whether the operated button is the remote shooting button 505 included in the menu. If the remote shooting button 505 is operated, the control unit 201 advances the processing to step S808, and shifts to the remote shooting processing. On the other hand, if a button other than the remote shooting button 505 is operated, the control unit 201 advances the processing to step S809, and shifts to the corresponding processing.

FIG. 8B shows the details of the processing in step S808. In the following, the remote shooting processing will be described with reference to the drawing.

First, in step S821, the control unit 201 waits for a cancellation response to the long polling from the digital camera 100. This corresponds to S606 in FIG. 6.

Next, in step S822, the control unit 201 waits for a response to the remote shooting request. This corresponds to S608 in FIG. 6.

In step S823, the control unit 201 makes a request for a shooting parameter for the digital camera 100 with which it is communicating, and receives a response thereto. As a result, the control unit 201 can obtain characteristic information (e.g., a zoom magnification range) of the digital camera 100. Then, in step S824, the control unit 201 displays a live image and a live viewer for setting a shooting parameter on the display unit 206 (see FIG. 5F).

Thereafter, in step S825, the control unit 201 sends an acquisition request for a live image to the digital camera 100, and performs processing for receiving the requested image and displaying the image on the live viewer. Then, in step S826, the control unit 201 determines whether there is an input of an operation instruction on the live viewer, and, if not, the control unit 201 returns the processing to step S825. Accordingly, step S825 is repeatedly executed as long as the user does not perform any operation, and, therefore, a live image imaged by the digital camera 100 can be displayed on the display screen of the smart device 200.

Here, it is assumed that the user performs an operation for changing the shooting parameter, for example, the zoom magnification. In this case, the control unit 201 advances the processing from step S827 to step S828, sends a shooting request with the set parameter (here, the magnification) to the digital camera 100, and performs processing for receiving a response from the digital camera 100. Then, the control unit 201 returns the processing to step S825. Accordingly, thereafter, the smart device 200 can receive and display a live image that has been captured in accordance with the set parameter.

If the instruction from the user is depression of the shooting button 508, rather than changing of the shooting parameter, the control unit 201 advances the processing from step S829 to S830. In step S830, the control unit 201 sends a shooting request to the digital camera 100. In response to this request, the digital camera 100 will perform processing for imaging a high-resolution image using the imaging unit 102. Upon completion of imaging, the digital camera 100 sends a response indicating that imaging is completed, so that the control unit 201 of the smart device 200 receives that response.

Next, the control unit 201 requests a thumbnail of the image captured with the digital camera 100 in accordance with the request made in step S831, and acquires the thumbnail. Then, the control unit 201 displays the acquired thumbnail on the display unit 206 only for a preset time (e.g., 5 seconds), and thereafter returns the processing to step S825.

If it is determined that the instruction from the user is not a shooting instruction either, the control unit 201 advances the processing from step S829 to step S833. In step S833, the control unit 201 determines whether or not the button 509 is depressed, or in other words, whether or not an end instruction for remote shooting is provided. If not, the control unit 201 returns the processing to step S825. If the instruction is the end instruction for remote shooting, the control unit 201 advances the processing to step S834 in order to end the remote shooting processing. In step S834, the control unit 201 sends an end request for remote shooting to the digital camera, and receives a response indicating that the request is accepted. Thereafter, the control unit 201 returns the processing to step S802 in FIG. 8A. After the processing has returned to step S802, the control unit 201 will perform processing for sending a long polling request, the digital camera 200 will display the image selection screen (FIG. 5A) again, and the smart device 200 will display the menu screen (FIG. 5B) for communication with the digital camera.

Through the above-described processing, the digital camera 100 and the smart device 200 can transition from the push sending state to the remote shooting state.

Transition from Remote Shooting to Push Sending

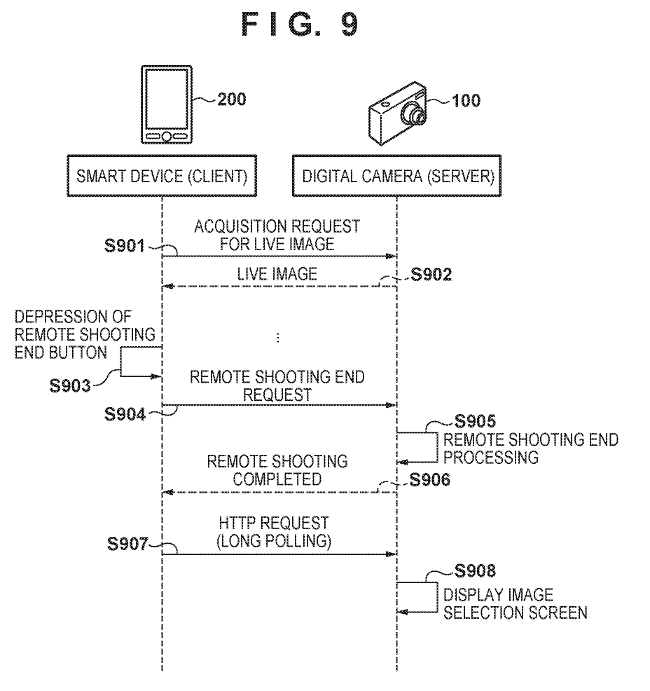

Next, the processing performed when the digital camera 100 and the smart device 200 exit from the remote shooting state and returns to the push sending state will be described with reference to FIGS. 5A to 5G and FIG. 9.

FIGS. 5A to 5G are diagrams showing examples of the screens on the digital camera 100 and the smart device 200. FIG. 9 is a diagram showing a sequence performed when the digital camera 100 and the smart device 200 exit from the remote shooting state and returns to the push sending state.

First, in step S901, the smart device 200 sends an acquisition request for a live image to the digital camera 100.

Next, in step S902, the digital camera 100 sends a live image to the smart device 200, and the smart device 200 displays the live image.

By repeatedly performing steps S901 and S902, a live view of the digital camera 100 can be displayed on the smart device 200. The smart device 200 displays a live image as shown in FIG. 5F, allowing the digital camera 100 to be operated to perform shooting and setting.

Next, in step S903, the remote shooting processing is ended by the user depressing the remote shooting end button (the “Back” button 509 in FIG. 5F) displayed on the screen of the smart device 200.

Next, in step S904, the smart device 200 sends a remote shooting end request to the digital camera 100.

Next, in step S905, the digital camera 100 receives the remote shooting end request sent in step S904, and executes remote shooting end processing. The digital camera 100 ends the processing relating to shooting, such as retraction of the lens barrel.

Next, upon completion of the remote shooting end processing in step S905, the digital camera 100 sends, in step S906, a completion notification for the remote shooting processing to the smart device 200. Upon reception of the completion notification for the remote shooting processing, the smart device 200 returns to the operation menu screen as shown in FIG. 5B, allowing the user to select the operations displayed on the operation menu.

The foregoing corresponds to a case where the processing returns to step S802 in FIG. 8A if an instruction to end remote shooting is performed in FIG. 8B.

Next, in step S907, the smart device 200 sends a long polling request to the digital camera 100.

Next, in step S908, the digital camera 100 that has received the long polling request transitions to the image selection screen shown in FIG. 5A, allowing the user to select an image and start push sending.

In this manner, the digital camera 100 and the smart device 200 can also transition from the remote shooting state to the push sending state.

As described above, according to the first embodiment, if a remote shooting request is received from the smart device before push sending is started in the digital camera, a cancellation response to the long polling request is sent. Then, thereafter, the digital camera transitions to the processing of the remote shooting request, thus making it possible to perform remote shooting without continuously using the resource.

### Second Embodiment

Case where Response to Long Polling Request from Camera Collides with Request from Smart Device

After completion of establishing connection between the digital camera 100 and the smart device 200, the user can operate the digital camera 100 to select an image, and send the image by push sending to the smart device 200. Simultaneously therewith, the user can also operate the smart device 200 to transition to processing such as remote shooting. That is, the user can simultaneously depress the push sending start button of the digital camera 100 and the remote shooting start button of the smart device 200. Therefore, the processing performed in a case where the processing for starting push sending from the digital camera collides with the processing for starting remote shooting from the smart device will be described.

First, with reference to FIGS. 5A to 5G, FIG. 10, and FIG. 11, a description will be given of a case where the digital camera 100 receives a remote shooting start request from the smart device 200 before returning a response to a long polling request to the smart device 200 after image selection from the user.

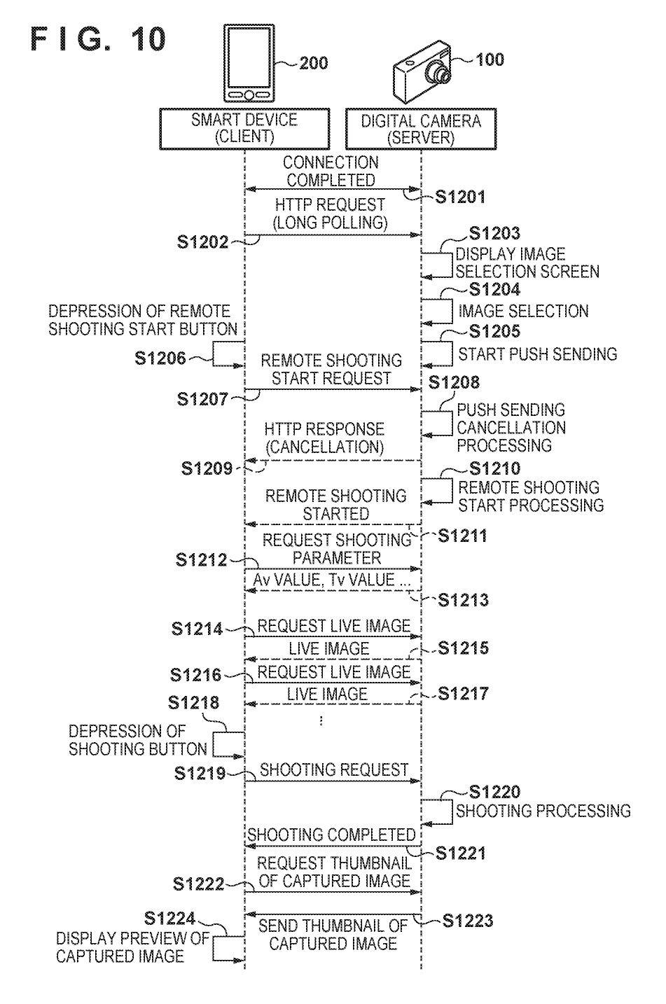

FIG. 10 is a diagram showing a sequence performed in the digital camera 100 and the smart device 200 in a case where the digital camera 100 receives a remote shooting start request from the smart device 200 before returning a response to a long polling request to the smart device 200 after image selection.

Steps S1201 to S1204 are the same as steps S401 to step S404 in FIG. 4, and, therefore, the description thereof has been omitted.

In step S1205, the user operates the digital camera 100 to instruct to start push sending of the image selected in step S1204 to the smart device 200. By selecting the send button 503 in FIG. 5A, it is possible to start sending the image to the smart device 200.

In step S1206, the user operates the smart device 200 to instruct to start remote shooting. By depressing the remote shooting button 505 in FIG. 5B, it is possible to start remote shooting.

Next, in step S1207, the smart device 200 sends a remote shooting start request to the digital camera 100. In the second embodiment, it is assumed that the instruction to start push sending in the digital camera 100 in step S1205 and the instruction to start remote shooting in the smart device 200 in step S1206 are performed at substantially the same time. Furthermore, the reception of the remote shooting start request in the digital camera 100 in step S1207 is performed after depression of the push sending start button in the digital camera 100 in step S1205 and earlier than the reception of the response to the long polling request to the smart device 200. After step S1205, if the response to the long polling request is received earlier than the reception of the remote shooting start request in step S1207, the remote shooting start request is ignored, and the push sending shown in FIG. 4 is performed.

Next, in step S1208, the digital camera 100 cancels the push send processing started in step S1205. That is, the control unit 101 of the digital camera 100 discards the response that has been prepared for the long polling request.

Steps S1209 to S1224 are the same as steps S606 to step S621 in FIG. 6, and, therefore, the description thereof has been omitted.

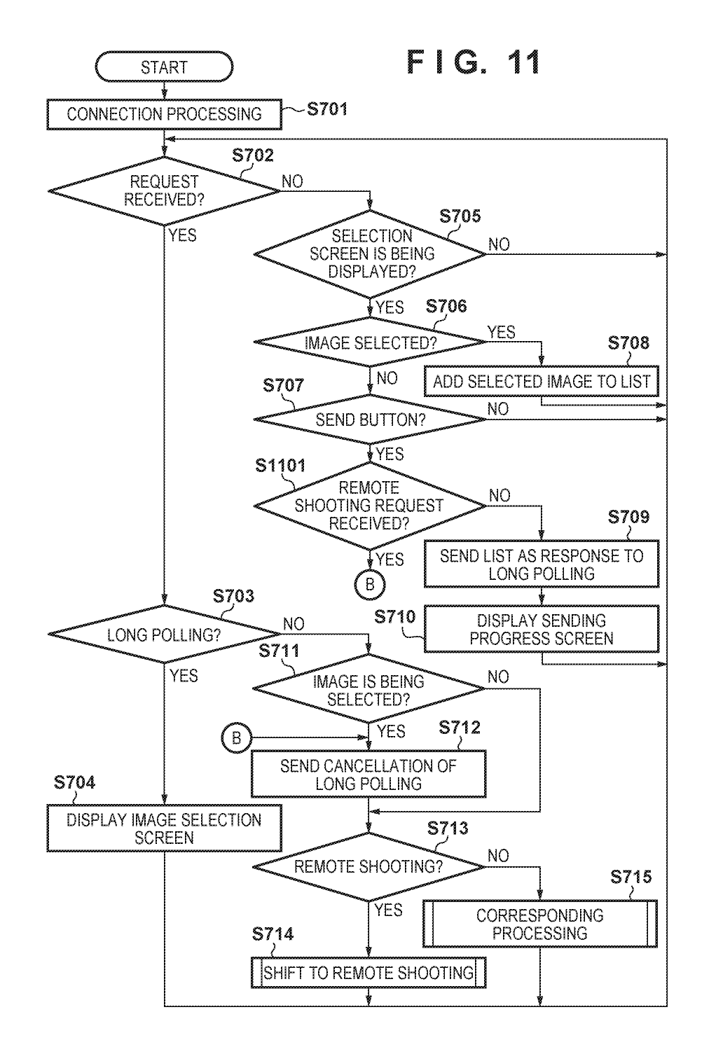

FIG. 11 is a flowchart illustrating the processing performed in the digital camera 100 when the digital camera 100 receives a remote shooting start request from the smart device 200 before returning a response to the long polling request to the smart device 200 after selection of an image. Each process in the flowchart is implemented by the control unit 101 loading a program stored in the non-volatile memory 103 into the work memory 104, and executing the program.

The different between FIG. 11 and FIG. 7A according to the first embodiment lies in the addition of step S1101 of determining whether a remote shooting request is received from the smart device immediately after determining in step S707 that depression of the send button 503 in FIG. 5A has been performed. In step S1101, if the control unit 101 determines that a remote shooting request has been received, the processing does not advance to step S709, but advances to step S711, in which a response indicating cancellation to the long polling is returned (corresponding to step S1209 in FIG. 10). Thereafter, the result of step S712, in which determination for remote shooting is performed, will always be Yes, so that the processing will shift to remote shooting, making it possible to implement the sequence shown in FIG. 10.

As described above, it is possible to give priority to remote shooting when a remote shooting request from the smart device 200 is made earlier than the reception of a response to the long polling request.

If the processing for starting push sending from the digital camera collides with the processing for starting remote shooting from the smart device, priority may be given to the operation on the digital camera, and a busy state notification may be sent to the smart device.

FIG. 5G shows a screen display example when the smart device 200 receives a busy state notification from the digital camera 100. If the user depresses the button so as to operate the smart device 200 to transition to remote shooting while operating the digital camera 100, a busy state notification is given from the smart device 200 to the digital camera 100. On the smart device 200 that has received the busy state notification, words such as “Inoperable because the camera is being operated” are displayed so as not to allow the user to perform an operation, as indicated by reference numeral 513 in FIG. 5G. A state in which the digital camera 100 is being operated is, for example, a state in which just one image is selected in the digital camera 100 by the user operation, and, in such a state, a busy state notification is sent to the smart device 200 even if a remote shooting start request arrives.

As described above, according to the second embodiment, if a remote shooting start request arrives from the smart device when push sending is to be performed in the digital camera, it is possible to transition to remote shooting by giving priority to the remote shooting start request from the smart device if the remote shooting start request is received before a response to the long polling request is sent.

If the user is selecting an image in the digital camera in order to send the image by push sending, it is possible to prevent the processing from transitioning to remote shooting during selection of the image by sending a busy state notification for the remote shooting start request from the smart device.

### Third Embodiment

Case where Request from Smart Device is Other than Remote Shooting

Although the operation performed in the smart device after completion of establishing connection between the digital camera and the smart device has been described as being remote shooting in the first and second embodiments, a case where the operation in the smart device is other than remote shooting will be described in the third embodiment.

Examples of the functions that can be operated in the smart device after completion of establishing connection between the digital camera and the smart device include “List of images included in the camera”, “Remote shooting”, “Location information”, and “Camera settings” as indicated by reference numerals 504 to 507 in FIG. 5B.

The processing performed in the case where an operation other than remote shooting is performed is the same as the processing performed when an operation for remote shooting is performed. For example, in the case where the operation “List of images included in the camera” is performed at the smart device, upon receiving a request to start displaying the list of images included in the camera, the digital camera sends a cancellation response to the long polling request to the smart device, and thereafter performs processing for the request to display a list of the images included in the camera. If the digital camera receives some request from the smart device, the digital camera first sends a cancellation response to the long polling request, and thereafter performs processing for the received request.

As indicated by reference numerals 504 to 507 in FIG. 5B, when one of “List of images included in the camera”, “Remote shooting”, “Location information”, and “Camera settings” is operated, according to FIG. 7A, a cancellation response to long polling is sent (S712) regardless of the type of the operation in the case of the image selection screen, and thereafter the processing advances to step S715, in which the corresponding processing is performed. Accordingly, the above-described third embodiment can be implemented.

The same applies to a case where the start of push sending from the digital camera collides with the request to start other processing from the smart device after completion of establishing connection between the digital camera and the smart device. If another request arrives before a cancellation response to a long polling request is sent in the digital camera, priority may be given to the other request. Alternatively, if another request arrives while the user is selecting an image to be sent by push sending in the digital camera, a busy state notification may be sent, and a warning indication may be issued on the smart device side.

As described above, according to the third embodiment, even if the digital camera receives a request other than remote shooting, the digital camera first sends a cancellation response to a long polling request, and thereafter performs the processing corresponding to the received request, thereby making it possible to transition to another processing without continuously using the resource.

If a request arrives from the smart device when the digital camera attempts to perform push sending, it is possible to transition to the operation specified from the smart device by giving priority to the request from the smart device if the request is received before a response to the long polling request is sent.

When an image is being selected in the digital camera in an attempt to send the image by push sending, it is possible to prevent the processing from transitioning to another operation during the image selection by sending a busy state notification for the request from the smart device.

As described above, according to the present invention, if the digital camera receives some request from the smart device, the digital camera sends a cancellation response to a long polling request, and thereafter performs the processing corresponding to the received request, thereby making it possible to transition to another processing without continuously using the resource.

When some request arrives from the smart device when the digital camera attempts to perform push sending, it is possible to transition to the operation designated from the smart device by giving priority to the request from the smart device if the request is received before a response to the long polling request is sent.

Furthermore, when an image is selected in the digital camera in order to send the image by push sending, it is also possible to prevent transition to another processing during image selection by sending a busy state notification for the request from the smart device.

Note that the present invention adopts a configuration in which a long polling request is sent from the smart device to the digital camera immediately after completion of establishing connection, and the digital camera receives the long polling request, and transitions to the image selection screen, making it possible to start push sending. However, it is also possible to adopt a configuration in which a long polling request is not sent from the smart device to the digital camera at the time of completion of establishing connection, and, for example, if the smart device includes a button for instructing to start push sending, a long polling request is sent to the digital camera when that button is depressed, thus making it possible to start push sending from the digital camera. With such a configuration, it is possible to transition to push sending at the timing desired by the user.

The present invention adopts a configuration in which if another request is received from the smart device when an image is being selected in the digital camera, a notification indicating that the digital camera is performing processing and is thus in a busy state is sent to the smart device, and a warning indication is issued on the smart device side. However, it is also possible to adopt a configuration in which if another request is received from the smart device while an image is being selected in the digital camera, a warning indication may be issued on the digital camera side. With such a configuration, when the digital camera is being operated to select an image, it is possible to know, on the digital camera being operated, that some request has arrived from the smart device.

The present invention adopts a configuration in which if some request is received from the smart device in the digital camera after completion of establishing connection between the digital camera and the smart device, a cancellation response to the long polling request is sent. However, it is also possible to adopt a configuration in which a cancellation response is also sent to the smart device if it is determined that push sending cannot be performed in the digital camera, for example, when there is no image that can be sent. With such a configuration, it is possible to inform the smart device of the fact that push sending cannot be performed in the digital camera, and display a warning indication or the like on the smart device.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-091944, filed May 2, 2017 which is hereby incorporated by reference herein in its entirety.

What is claimed is:

1. A communication apparatus comprising:
a communication unit that communicates with a client by using a request/response communication protocol;
a processing unit that performs processing corresponding to a request received by the communication unit from the client, and enables the communication unit to send a response to the received request to the client; and
a control unit that, when the communication unit receives a predetermined polling request, and the processing unit receives another request from the client before sending a response to the predetermined polling request to the client, sends a cancellation response to the predetermined polling request from the communication unit, and causes the processing unit to execute processing corresponding to the other request.

2. The apparatus according to claim 1, further comprising: a display unit; a storage unit capable of storing a plurality of images; and an operation unit for inputting an instruction from a user,
wherein the processing unit:
when the predetermined polling request is received from a client, displays, on the display unit, an image to be sent to the client so as to enable a user to select the image from among images stored in the storage unit;
generates a list representing images to be sent in accordance with an image selection through the operation unit; and,
when a sending instruction is input through the operation unit, sends the list as a response to the predetermined polling request.

3. The apparatus according to claim 2, further comprising an imaging unit for acquiring images that are to be stored in the storage unit.

4. The apparatus according to claim 3, wherein the other request includes at least one of a request for remote shooting using the imaging unit, an acquisition request for a list of images stored in the storage unit, a request to add location information to an image, and a setting request for an operating environment.

5. The apparatus according to claim 2, wherein, when a cancellation response to the predetermined polling request is sent, and the processing corresponding to the other request is executed by the processing unit, the control unit displays, on the display unit, an indication that the operation unit is inoperable.

6. The apparatus according to claim 1, wherein, when the other request is received during processing of the predetermined polling request performed by the processing unit, the control unit sends, from the communication unit, a response indicating that the apparatus is in a busy state for the other request.

7. The apparatus according to claim 4, wherein, when the other request is a request for remote shooting using the imaging unit, the control unit notifies the client that preparation for the remote shooting is completed upon completion of preparation for the remote shooting.

8. The apparatus according to claim 1, wherein the request/response communication protocol is HTTP.

9. A control method of a communication apparatus including a communication unit that communicates with a client by using a request/response communication protocol, the method comprising:
performing processing corresponding to a request received by the communication unit from the client, and enabling the communication unit to send a response to the received request to the client; and,
when the communication unit receives a predetermined polling request, and another request is received from the client before a response to the predetermined polling request is sent to the client, sending a cancellation response to the predetermined polling request from the communication unit, and executing processing corresponding to the other request.

10. The method according to claim 9, wherein the apparatus includes: a display unit; a storage unit capable of storing a plurality of images; and an operation unit for inputting an instruction from a user,
wherein the method further comprises:
when the predetermined polling request is received from a client, displaying, on the display unit, an image to be sent to the client so as to enable a user to select the image from among images stored in the storage unit;
generating a list representing images to be sent in accordance with an image selection through the operation unit; and,
when a sending instruction is input through the operation unit, sending the list as a response to the predetermined polling request.

11. A non-transitory computer readable storage medium storing a program that is read and executed by a computer including a communication unit that communicates with a client by using a request/response communication protocol, wherein the program causes the computer to:
perform processing corresponding to a request received by the communication unit from the client, and enable the communication unit to send a response to the received request to the client; and,
when the communication unit receives a predetermined polling request, and another request is received from the client before a response to the predetermined polling request is sent to the client, send a cancellation response to the predetermined polling request from the communication unit, and execute processing corresponding to the other request.

12. A communication system comprising: an imaging apparatus including a first communication unit; and a terminal apparatus including a second communication unit,
wherein the imaging apparatus functions as a server by using a request/response communication protocol with the first communication unit,
wherein the terminal apparatus functions as a client by using a request/response communication protocol with the second communication unit,
wherein the terminal apparatus includes:
a first processing unit that sends a predetermined polling request to the imaging apparatus, and displays a menu of a plurality of processing items for the imaging apparatus;
a second processing unit that, when one of the processing items of the menu is selected by a user before a response to the predetermined polling request is received from the imaging apparatus, sends a request for the selected processing item to the imaging apparatus, receives a cancellation response to the predetermined polling request, and thereafter shifts to processing corresponding to the request for the selected processing item; and
a third processing unit that, when a response to the predetermined polling request is received from the imaging apparatus without any one of the processing items of the menu being selected by the user, shifts to processing for acquiring an image described in the response,
wherein the imaging apparatus includes:
a fourth processing unit that displays, when the predetermined polling request is received from the terminal apparatus during communication with the terminal apparatus, a list of imaged images stored in the imaging apparatus so as to be selectable by the user, accepts selection of an image by the user, and sends, when a sending instruction is input from the user, information specifying the selected image to the terminal apparatus as a response to the predetermined polling request; and
a fifth processing unit that sends, when another request is received from the terminal apparatus before a response to the predetermined polling request is sent to the terminal apparatus by the fourth processing unit, a cancellation response to the predetermined polling request, and performs processing corresponding to the other request.
